(19) United States
(12) Patent Application Publication
(10) Pub. No.: US 2026/0036226 A1
(43) Pub. Date: Feb. 5, 2026

(54) ASSEMBLY FOR VENTING A WOOD STOVE, WINDOW UNIT AS PART OF THE ASSEMBLY, AND METHOD OF USE

(71) Applicant: NUVATION LLC, Cassville, MO (US)

(72) Inventors: Don BELL, Cassville, MO (US); Derek BELL, Cassville, MO (US)

(73) Assignee: NUVATION LLC, Cassville, MO (US)

(21) Appl. No.: 19/286,438

(22) Filed: Jul. 31, 2025

Related U.S. Application Data
(60) Provisional application No. 63/677,782, filed on Jul. 31, 2024.

(51) Int. Cl. F16L 3/127; F16M 13/02; F23J 13/00; F24C 15/00

(52) U.S. Cl. CPC F16L 3/127; F16M 13/02; F23J 13/00; F24C 15/002

(57) ABSTRACT

A cantilevered window unit is provided that can be attached to a wood stove. The window unit allows a flue member to pass through the unit and extend upwardly on the outside of the structure containing the window unit. A unique roof bracket is employed to secure a vertical section of the flue member to the structure. Extension brackets can be employed in combination with the roof bracket to provide further support above and/or below the roof bracket location depending on the length of the flue member above or below the roof line.

### FIELD OF THE INVENTION

A window unit includes a box construction that includes a walled through-opening, sized to receive the flue pipe from an indoor woodstove. The window unit also includes a system that is designed to support the flue pipe extending outwardly from the window unit, preferably a tee connection as a part thereof. The system allows the flue pipe to vertically extend beyond the eave or other structure of a dwelling having the window unit installed therein.

### BACKGROUND ART

In the art, it is known to vent floor mounted air conditioners to the outside using an assembly that fits within the window of a dwelling. However, these assemblies are not designed to handle the hot gases that would normally be vented from a woodstove located in the interior of a dwelling.

D269,043 to Resnicoff discloses a window box that is adaptable to fit within a window. However, this design patent provides no other information as to the details of the window box.

There has been an increase in the desire for renovated houses and the use of woodstoves as part of these houses. However, not all houses are adaptable for installation of a new woodstove without extensive renovations to be made to accommodate venting of the flue gases from the woodstove. Thus, a need exists to provide an improved way for homeowners to have the benefit of a woodstove without the expense of having to perform major renovations to a dwelling to safely install the woodstove within the dwelling.

The invention responds to this need by providing an assembly that allows the venting of a woodstove using an existing window of a dwelling and avoids the need for extensive renovations to have the woodstove installed inside the dwelling.

### SUMMARY OF THE INVENTION

The invention is an improvement in techniques to easily install a wood burning fireplace or stove in a dwelling. More particularly, the invention allows the installation of the wood burning fireplace or stove without the need for extensive modifications to the inside of a structure that would house the stove or fireplace. One needs to merely cut an opening in a wall of the structure and employ the inventive window unit and its accompanying flue pipe assembly for easy installation.

On embodiment of the invention is an assembly for venting a woodstove through a window in a dwelling or structure. The assembly includes a window unit configured to fit within a window of the dwelling and means for supporting at least a portion of a flue pipe extending from the window unit to an extent that the flue pipe, when extending vertically, is clear of an eave/soffit or wall of the dwelling. Also included as part of the assembly are means for closing off a gap not occupied by the window unit when the window unit is installed in a window space.

The window unit is a metal box having a walled through-opening therethrough, the metal box having an interior space, the interior space including a collar surrounding walls of the walled through-opening, a space between the collar and the walls forming an insulating space, the interior space optionally including insulation therein.

The metal box includes a fresh air vent extending through the metal box to provide combustion air for the wood stove, the fresh air vent optionally including a door to allow closing and opening of the fresh air vent.

The means for supporting the flue pipe can include a base plate, extendable and lockable support rails configured to be attachable to the base plate and configured to be attachable to the metal box or be free standing; and extendable and lockable legs attachable to the base plate to support the base plate.

The means for closing off the gap can be an expandable/retractable member positioned on at least one side of the metal box.

The assembly can also include a flue pipe clamp, intended to secure the flue pipe outside of an eave of the dwelling.

The assembly described above can be using in a method of venting a woodstove using a window of a dwelling, the method including providing the assembly described above and installing the window unit in a window of a dwelling. The means for supporting an outside section of a flue pipe extending from the woodstove is positioned at a location outside of the dwelling so that the flue pipe, when extending vertically after extending horizontally from an outside of the metal box, clears an eave or wall of the dwelling.

For the method the metal box of the window unit can include a fresh air vent extending through the metal box to provide combustion air for the wood stove, the fresh air vent optionally including a door to allow closing and opening of the fresh air vent.

The invention also includes just the window unit described above as well as the unit in combination with the fresh air vent described above.

In another embodiment, a modified window unit is provided that uses a roof mounted member support device for supporting the flue pipe associated with the window unit. This support device includes a base plate including means for attaching the base plate to a roof and an attachment plate. A hinge is also provided, the hinge between the base plate and attachment plate, the hinge allowing an angle between a surface of the attachment plate and a surface of the base plate to change to accommodate a pitch of the roof.

The support device also includes means for attaching the attachment plate to at least one member support bracket, the means for attaching configured to attach to one or both of a member to be held by the roof mounted member support device and an extension bracket, the extension bracket including means for attaching the extension bracket to the member.

The means for attaching the base plate to the roof can be a plurality of openings or through holes in the base plate configured to receive fasteners for roof attachment.

The attachment plate can include a pair of plate flanges, each flange having an arcuate slot therein and the base plate includes a pair of base plate flanges, each base plate flange including an arcuate slot therein, the arcuate slots of the attachment plate aligned with the arcuate slots of the base plate, and at least one locking connector engaging adjacent arcuate slots of each of the plate portion and base plate, each at least one locking connector holding the pivotal attachment between the attachment plate and base plate in place for member support.

The means for attaching the attachment plate to the at least one member support bracket or extension bracket can be a plurality of openings or through holes in the attachment plate.

The member support bracket can be a strap configured to surround the member and be attached to the attachment plate using the means for attaching the attachment plate to the member support bracket.

The member support bracket can include a means for adjusting an angle of the member with respect to the attachment plate.

The adjusting means can include a bracket adapted to attach to the attachment plate, the bracket having an arcuate slot therein, the strap including an opening for receiving a fastener, the fastener engaging the arcuate slot and attaching the bracket to the strap, the arcuate slot allowing an angle between the bracket and the strap to be adjusted.

The support device can further include an extension bracket for attachment to the attachment plate and, optionally an additional member support bracket assembly attaching to the extension bracket.

In yet another embodiment, the invention also includes an assembly for venting a woodstove through a window in a dwelling, the assembly including a window unit configured to fit within a window of the dwelling and means for supporting at least a portion of a flue pipe extending from the window unit to an extent that the flue pipe, when extending vertically, is clear of an eave/soffit or wall of the dwelling. The assembly also includes a means for closing off a gap not occupied by the window unit when the window unit is installed in a window space. The window unit is a metal box having an inlet opening and outlet opening to receive a portion of the flue pipe, the metal box having an interior space, a bottom of metal box open, the metal box including an air intake port, the air intake port having an outlet on one face of the metal box and an inlet in the interior space of the metal box, the inlet including an air intake regulator to adjust air intake through the inlet opening.

The window unit can include a collar adapted to mount to a portion of the flue pipe extending from the outlet opening, mounting of the collar to the portion of the flue pipe restricting movement of the flue pipe in the window unit.

The window unit can also include a means for locking in place a window receiving the window unit, wherein the locking in place means can be a bracket with at least one set screw, the bracket including a lip to engage a groove of a window casing, the at least one set screw positioned in the bracket to move the bracket with respect to the window casing to secure the lip in the groove and prevent movement of a window sash.

The invention also includes the combination of the window unit and the roof mounted member support device, wherein the roof mounted member support device and window unit can have the features described above.

### BRIEF DESCRIPTION OF THE DRAWINGS

FIG. 1 shows one embodiment of the inventive assembly in use.

FIG. 2 shows an outside perspective view of the window unit of the assembly of FIG. 1.

FIG. 3 shows an inside perspective view of the window unit without a flue pipe passing therethrough.

FIG. 4 shows a bottom perspective view of a portion of the support mechanism for a portion of the flue pipe extending outwardly from the window unit.

FIG. 5 shows another embodiment of the invention as compared to FIGS. 1-4, using a differently configured window unit and a different means for supporting the flue pipe.

FIG. 6 shows another view of the window unit 60 with its exterior flue pipe.

FIGS. 7A and 7B shows more detail of the window unit.

FIG. 7C shows the window unit with a lock guide.

FIG. 7D shows an additional elevational view of the lock guide 85 of FIG. 7C.

FIG. 8 shows the locks of FIGS. 7A-7D in more detail.

FIG. 9 shows another feature of the invention as a lock collar.

FIG. 10 shows one embodiment of the means for supporting the flue pipe.

FIG. 11 shows the use of an extension bracket in combination with the bracket 101 to provide additional support to the flue pipe vertical section.

FIG. 12 shows another view of the window unit using the bracket and extension bracket.

FIG. 13 shows another embodiment of the invention, wherein a pair of extension brackets are used for flue pipe.

FIG. 14 shows a use of the bracket in a different mode of attachment to a flue pipe.

FIG. 15 show the use of the extension bracket with a pair of the modified member support brackets of FIG. 14.

FIG. 16 shows the use two extension brackets with the modified member support bracket of FIG. 14.

FIG. 17 shows the use of an optional brace assembly that is located between a lower portion of the vertical section of flue pipe and a horizontal section extending from the window unit.

FIG. 18 shows the wall unit having a cantilevered open bottomed box similar to that of window unit.

FIG. 19 shows a disassembled view of the roof bracket of FIG. 11 in connection with the extension brackets.

### DETAILED DESCRIPTION OF THE INVENTION

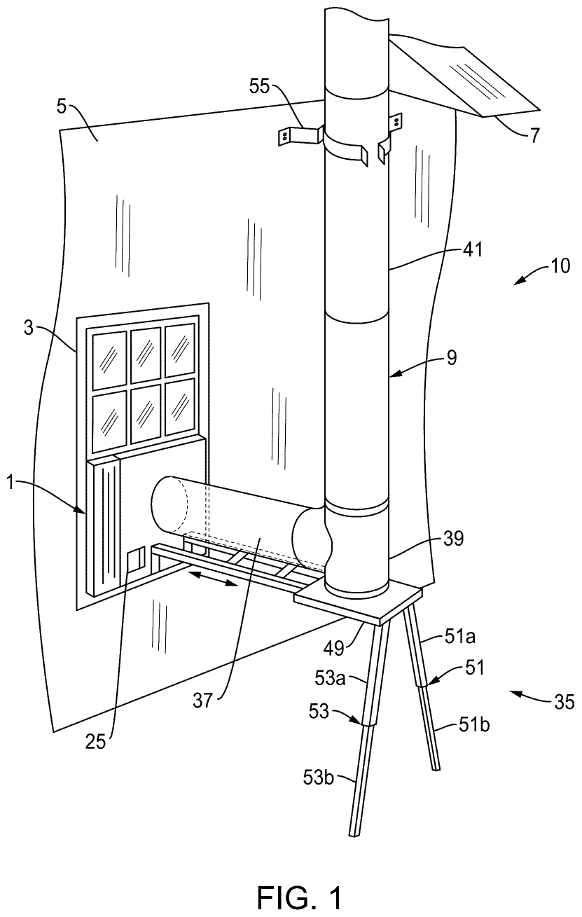

One embodiment of the inventive assembly for venting a woodstove using an existing window of a dwelling or other structure in need of heating is shown in FIGS. 1-4. The assembly of component parts is designated as reference numeral 10 in FIG. 1. The assembly 10 includes a window unit 1, which is configured to removably fit into a window 3 of the structure, a wall 5 thereof containing the window 3. The structure is also shown with an eave or soffit 7 that extends from the wall 5 as is well known in window-containing structures. These eaves or soffits can extend from the wall in various lengths, e.g., 3 feet or more depending on the overall construction of the structure.

The window unit 1 is configured to accommodate a flue pipe running from the woodstove (not shown) on the other side of the wall 5 and allow the flue pipe to extend through the window unit 1, the outside section of the flue pipe designed generally by the reference numeral 9. This outside section of flue pipe 9 includes a first portion aligned in a generally horizontal orientation, a tee section, and a vertical portion, the horizontal portion and vertical portion each having an appropriate length such that the outlet of the vertical section is sufficiently and safely spaced from the structure. Local building codes will control the exact height and spacing as would be known in the art. More details of the manner in which at least a portion of the outside section is supported is found below.

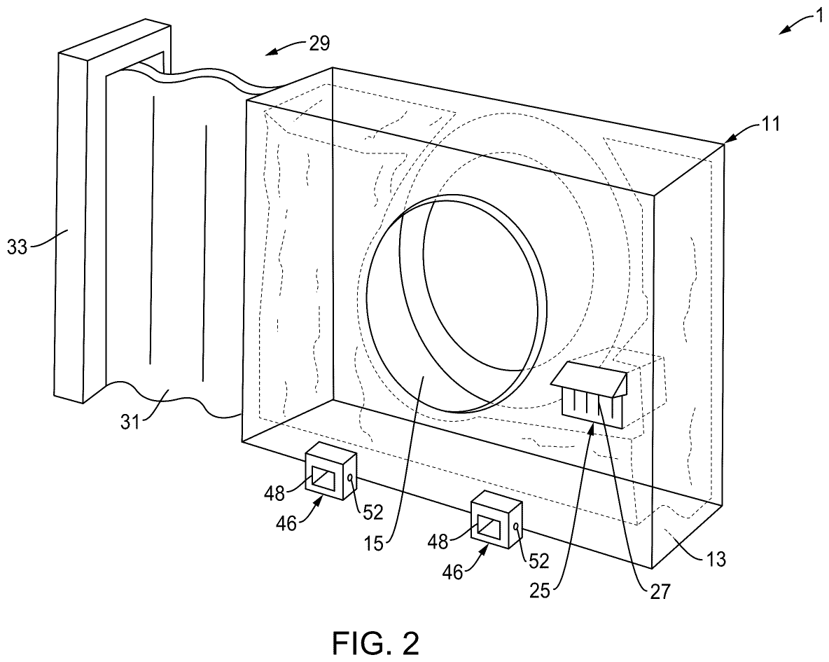

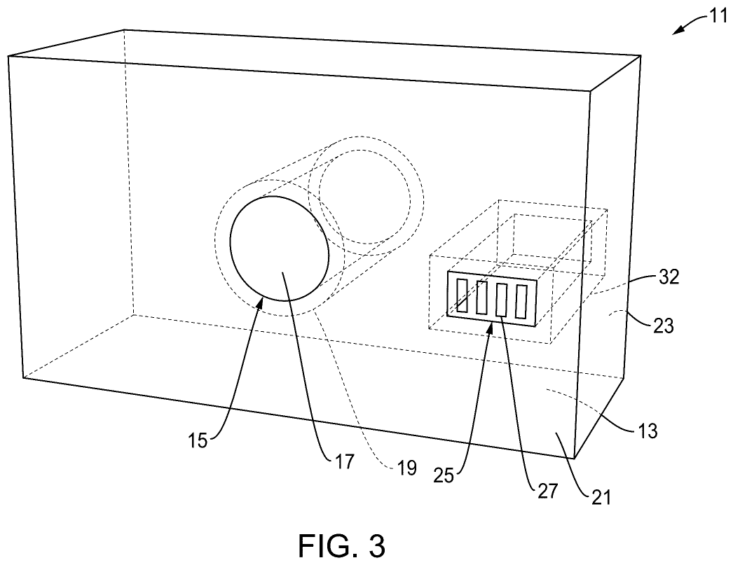

The window unit 1 is shown in more detail ins FIGS. 2 and 3. The window unit includes a metal box 11 having an internal space 13 and walled through-opening 15, 7A the wall of the through opening designated by the reference numeral 17. The wall 17 is surrounded by a collar 19 that extends between the inside wall 21 and outside wall 23 of the window unit 1. The collar 19 is positioned to create an annulus surrounding the wall 17. This creates an insulating space as is normally required by code for flue pipes that are within a structure or dwelling. A 2 inch spacing for the annulus is an example of spacing and other spacings could be employed as local codes would allow.

The internal space 13 is preferably filled with an insulation, for example, fiberglass, to provide further insulation from heat conducting from the flue pipe to the wall 17 and then to other parts of the metal box 11. The metal of the box can be any kind of metal that would be suitable to allow a flue pipe and heat associated therewith to be in contact with.

Referring to FIG. 2 specifically, the metal box can also include a fresh air vent that would pass through the metal box and bring combustion air from outside for supply to the woodstove. The vent is designated by the reference numeral 25 and could include louvers 27 if so desired. Although not shown, the vent could also have a sliding door or other mechanism to control the size of the vent opening and the amount of combustion air let into the structure. One example of a door would be a 3 inch circular adapter that could be attached to the metal box 11 and rotate to cover or expose the vent. Other door mechanisms for vents could also be employed as are known in the art. The control of the vent opening is preferably located on the inside wall 21 of the window unit 1 so that vent opening size control can be done inside rather than outside the dwelling. Although not shown, the vent construction could be the same as the opening for the flue pipe. That is, a wall forms the through hole for the air vent and then a collar surrounds the wall to form an insulating space around the wall. An example of this construction is shown in FIG. 3, wherein the vent 25 with its louvers 27 has a rectangular shape with a rectangular shaped collar 32 surrounding it.

The window unit 1 also has a mechanism to fill any gaps left in the window space once the window unit is installed in a window space. In the embodiment of FIG. 2, an accordion-like mechanism 29 could be employed, wherein flexible material 31 is attached to one side of the box 11 with the other side of the flexible material having a terminating portion 33 that would butt up against a side of the window for sealing purposes. The flexible material is similar to that found in air conditioners, wherein it can compress and expand to seal any window space not occupied by the metal box 11. The mechanism shown in FIG. 2 is just one example of a mechanism for closing off a portion of the window space not occupied by the metal box. Any other means could be employed for closing off the portion of the unoccupied window, e.g., a roller shade. This means for filling any gaps left in the window once the metal box is placed in the window opening provides a weather tight, energy-efficient, and customizable fit for the window unit. The means for filling the gap can be located on both sides of the window box or just one side as shown in FIG. 2.

As part of the installation of the window unit, the window can be opened and the window unit fit into the window space. The window sash can be lowered so that the lower rail thereof would engage a top portion of the metal box and gap filling means to keep the window unit in place. This action is similar to how window air conditioners are installed in window, wherein the window helps keep the air conditioner in place. Fasteners could be employed as well to improve the engagement between the top surface of the metal box 11 and lower rail of the window sash as well as between the terminal portion 33 of the gap filling means and window sill or window jamb.

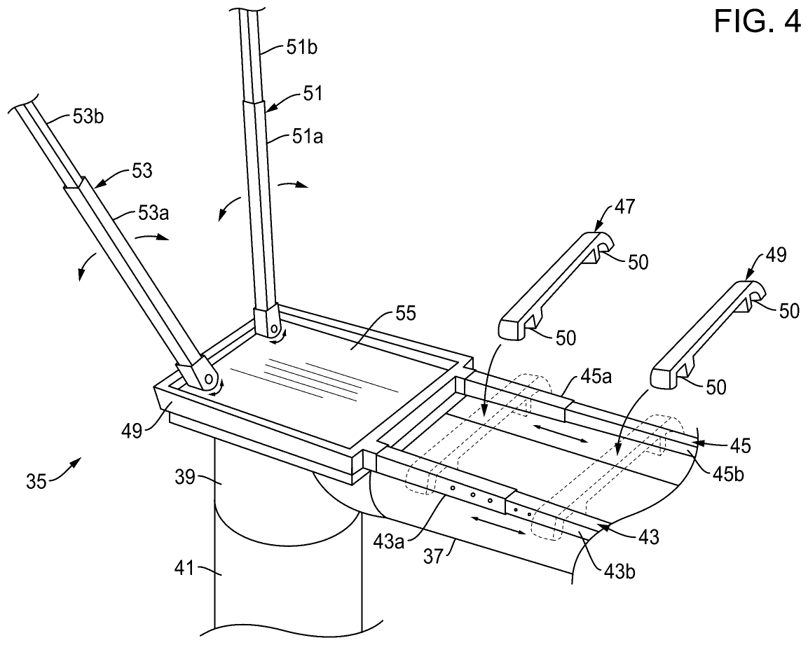

Referring again to the outside section 9 of flue pipe in FIGS. 1, the assembly includes a flue pipe supporting mechanism, which is designated by the reference numeral 35. The purpose of the flue pipe supporting mechanism is to provide support for at least a portion of the outside section 9, which includes the horizontal portion 37 of the flue pipe, the tee section 39, and the vertical portion 41. As shown in FIG. 1, the vertical portion 41 of the outside section 9 is supported so that it can clear the soffit or eave 7 of the structure. One example of this flue pipe supporting mechanism is shown in FIGS. 1 and 4. This mechanism includes an expandable rail system that includes a pair of a set of telescoping rails 43 and 45.

FIG. 3 shows two rails 43a-43b, 45a-45b, in each respect set 43 and 45, but more rails could be employed depending on the desired length of expansion of the rail system. The telescoping rails can employ the well-known spring biased pins in the smaller rail and openings in the larger rail to set the length of expansion and lock the rails in place.

Optionally, support brackets 47 and 49 can be employed, the support bracket 47 sized to clamp onto the larger rails 43a and 43b and the support bracket 49 sized to clamp onto the smaller rails 43b and 45b. To achieve the clamping onto the rails, the brackets could include rubberized claw portions 50, that allow the clamping parts of the brackets to conform to the shape of the rails. Other kinds of support brackets could also be used as means for providing a lateral support to the rails when in use, as well as means to facilitate attachment of the brackets to the rails, e.g., fasteners, clips, and the like.

One end of the rail sets 43 and 45 are removably connected to a base plate 49. This connection can be any means for connecting the ends of the rails (or whatever support is used for the outside section of flue pipe), e.g., using fasteners and the like. The push-button pop out connection and pre-drilled holes used to adjust the expansion of the rail sets can also be employed to link the ends of the rail sets to the base plate. The other end of the rail sets 43 and 45 are configured to connect to the outside face 23 of the metal box 11. An example of a connection is a pair of slotted receptacles 46 extending from the metal box, the slots spaced apart to set the spacing between the rail sets 43 and 45, each slot opening 48 sized to receive the rail so that it can be held in the slot using a screw or other fastening member. Reference numeral 52 represents a pre-drilled hope would receive one of the pop-up pins at the end of the rail sets 43 and 45 for attachment purposes. Again, the removable connection between the rail sets 43 and 45 and the base plate 49 are examples only and other connection means could be used as would be known in the art.

The base plate 59 also includes a pair of telescoping or expandable legs 51 and 53. The legs 51 and 53 are shown with a pair of legs 51a-51b and legs 53a-53b, the position of the smaller legs 51b and 53b expanded and locked in the same way that the rails sets 43 and 45 and expanded and locked. The attachment of the ends of the legs 51a and 53a to the underside 55 of the base plate 49 can be a rotatable attachment to allow the rail sets 51 and 53 to rotate or swivel in place and to be able to move the distal end of each leg 51b and 53b in different sites accommodate uneven ground for support of the outside section 9 of the flue pipe.

In the embodiment shown in FIGS. 1 and 4, the base plate 49 is positioned to support the tee section 39 of the outside section 9 in the proper location using the expandable rail sets 43 and 45 and the legs 51 and 53 so that the vertical portion 41 is positioned properly with respect to the soffit or eave 7 and/or wall 5 of the structure.

The tee section can be a 6 inch class A insulated tee, which are well known in the art, and one that also includes a clean out cap (not shown). The clean out is also optional but preferred as this makes it much easier to clean the flue pipe outer section 9 after extended use.

The flue pipe support mechanism or expandable rail system 35 is just one example of a mechanism that functions to support the outside section of the flue pipe so that the vertical portion of the outside section 9 is positioned to clear the soffit or eave or wall of a structure with the necessary clearance to meet building codes. Any means for supporting the flue pipe that extends outwardly from the window unit 1 can be employed as long as such means positions the vertical portion of the outside section of flue pipe so that it would clear the eave or soffit or wall of the structure having the window therein. While square rails that telescope, with the base plate, square legs for supporting the base plate, and attachment slots for the rails to attach to the window unit and base plate are exemplified, other expandable systems could be used. For example, the rails would be tubular in shape, the base plate could be a screen material rather than a solid plate as shown, more than two legs could be used to support the base plate and expandable rails. The expandable rail system could be free standing as well so that no connection to the window unit would be required. For example, the ends of the rail sets 43 and 45 could be attached to the structure of the dwelling or include a base plate and legs that would be securely embedded in ground to assure the stability of the free standing system. Preferably, the system is attached to the window unit as this assures its stability as compared to a ground mounting attachment. A single expandable rail set could be used as well providing it had the necessary strength and rigidity to support the outside section of flue pipe. The expandable rail system could also be configured to support the horizontal portion of the outside section of flue pipe as well.

In the event that there is no eave or soffit above the window, the means for supporting the outside section of flue pipe would just have to ensure that the vertical portion of the outside section is a safe distance from the exterior of the structure having the window therein. Whereas the expandable rail system would extend the base plate several feet from the window unit, it may be that the clearance from the exterior wall would only need to be a foot or so.

An eave bracket 55 can also be employed to stabilize the vertical portion 41 once the supporting mechanism 35 is put in place.

Typically, the flue pipe is 8 inch in diameter, but the window unit 1 could be made to accommodate different diameters of flue pipe.

While fiberglass insulation is exemplified for filling the interior space of the metal box, any kind of insulation could be used, e.g., blown in insulation, a foam insulation, and the like.

In use, the inventive assembly could come as a kit, with at least the metal box and its expandable rail system being part of the kit. The assembly is easily installed once the woodstove is in place. The window unit 1 is placed in the window space and the gap filling mechanism is manipulated to fill the space left between a side of the window unit and the jamb of the window frame. The expandable rail system can then be attached to the window unit with the rails expanded to the desired length for positioning of the base plate for t section support. The legs of the base plate are manipulated in terms of extension and placement to support the base plate. The flue pipe can then be manipulated to connect to the woodstove, pass through the window unit, wherein the tee section is connected to the flue pipe extending outwardly from the window unit and the vertical portion is connected to the tee section to complete the installation. The eave bracket can also be used to secure the vertical portion. The sequence of the steps above could be altered. For example, the outside section of the flue pipe could be erected and held in place with a temporary structure and then the expandable rail system could be erected for support of the outside section.

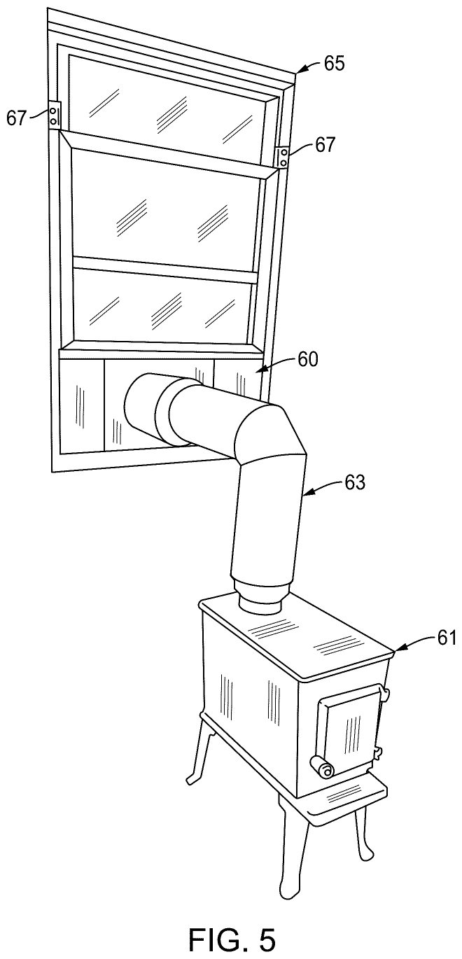

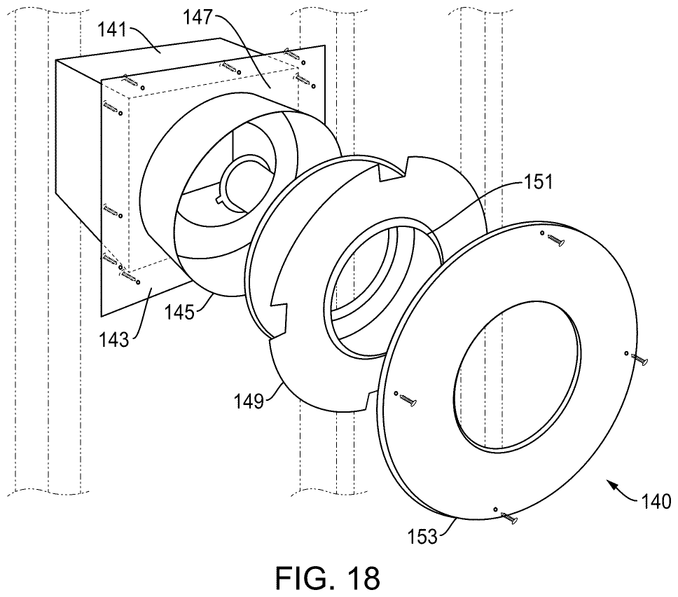

FIGS. 5-18 show other embodiments of the invention that use a differently configured window unit, a different kind of means for supporting the flue pipe extending from the window unit as compared to the embodiment of FIGS. 1-4, and a wall unit that can be used instead of the window unit. Whereas the FIGS. 1-4 embodiment used a sealed window unit and means for supporting the flue pipe using ground, the embodiment of FIGS. 5-17 uses a unique bracket that secures the flue pipe to a roof without the need for ground support. The embodiment of FIG. 18 shows a unit that is configured for wall installation rather than window installation. The wall unit of FIG. 18 can employ all of the supporting features associated with the window unit of FIGS. 5-17.

FIG. 5 shows the second embodiment of the window unit 60 in combination with a wood stove 61 and flue pipe 63. The window unit is positioned in the window 65 and includes locks 67, which are described in more detail below.

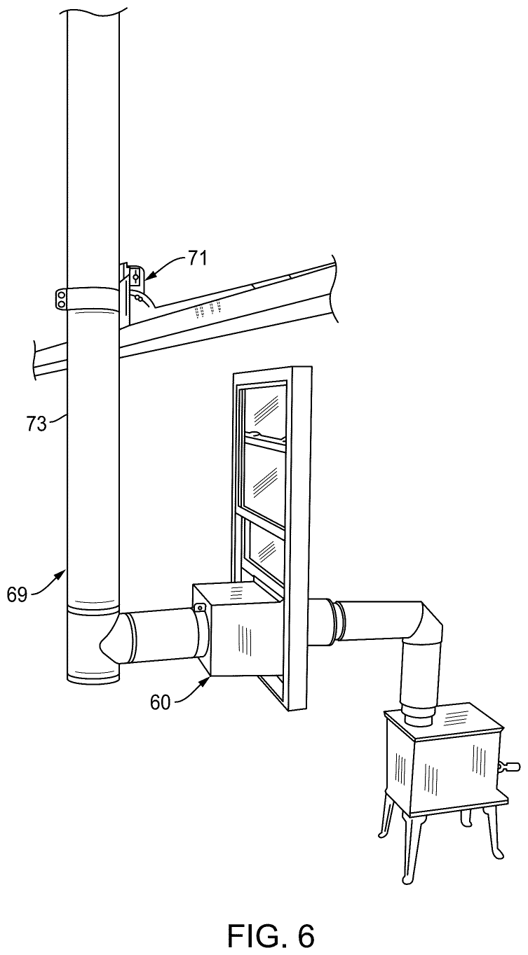

FIG. 6 shows another view of the window unit 60 with its exterior flue pipe designated by the reference numeral 69. A supporting or roof metal bracket 71 as the supporting means is shown attached to a vertical section 73 of the flue pipe 69. Unlike the first embodiment, the embodiment of FIG. 6 does not need any support means to hold the flue pipe using the ground.

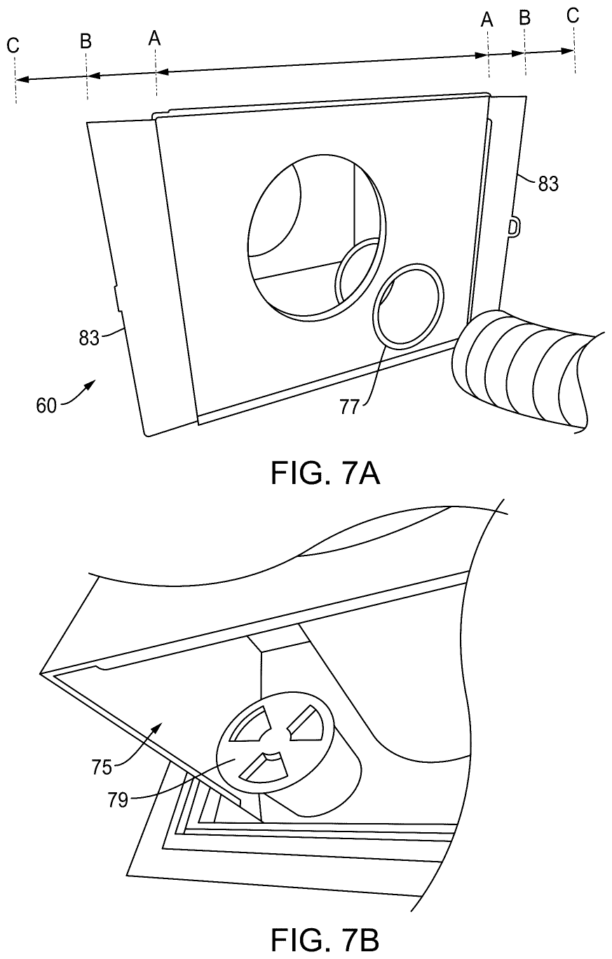

FIGS. 7A and 7B shows more detail of the window unit 60. Unlike the first embodiment, the window unit does not include a closed space. Rather, it includes an opening 75 in the front and rear faces of the window unit to allow the flue pipe to pass therethrough.

Similar to the window unit of the first embodiment, the window unit has an air intake port 77 and regulator 79 to control the amount of air flow into the structure having the wood stove placed therein. The regulator 79 is positioned within the space 75 created by the window unit and is accessible from a bottom of the window unit for movement thereof for air flow control.

As with the first embodiment, the window unit 60 includes a means to seal off the gap 82 between the window unit 60 and window frame 81. In this embodiment, the gap sealing means are panels 83 that can slide in and out of the window unit 60.

Referring to FIG. 7C, the window unit 60 can also include a lock guide 85 that has a particular profile 87. The profile includes a slot 89 that is designed to engage the window unit. The window sash is designed to engage the surface 91 of the profile with the leg 93 engaging an inward face of the window sash to keep the window unit secure in the window frame.

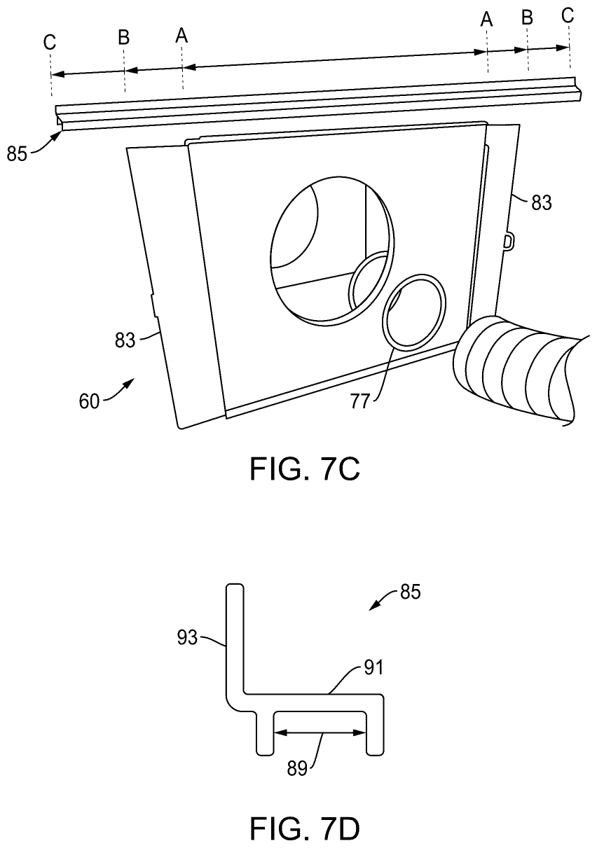

FIG. 7D shows an additional elevational view of the lock guide 85 of FIG. 7C. FIG. 8 shows the locks 67 in more detail. The locks are I-shaped with a lip (not shown) on one leg of the lock. The lip engages a groove in the window casing and turning of the threaded element 68 moves the lock in the direction of the axis of the threaded element, thus securing the lip in the window casing groove. The threaded element includes a set screw 68a, allen key 68b, and bracket 68c.

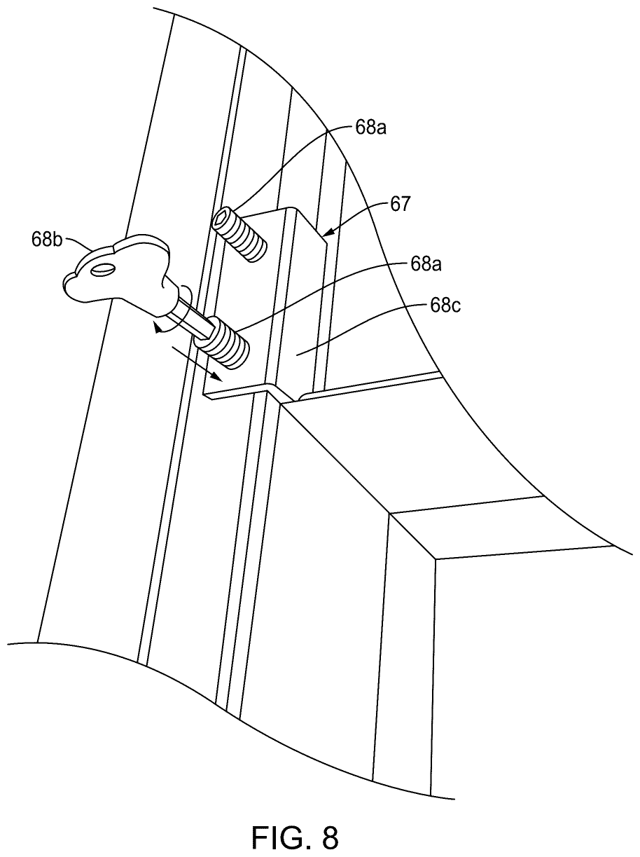

FIG. 9 shows another feature of the invention as a lock collar 95. The lock collar 95 is sized to fit around a horizontal portion 96 of the exterior portion 69 of the flue pipe extending from the outside face 97 of the window unit 60. The lock collar 95 has flanges 98 and is clamped and tightened using the fastener 99 onto the flue collar and also butted up against the face 97. The lock collar 95 prevents movement of the flue pipe towards the window unit 60 and provides more stability of the window unit when installed.

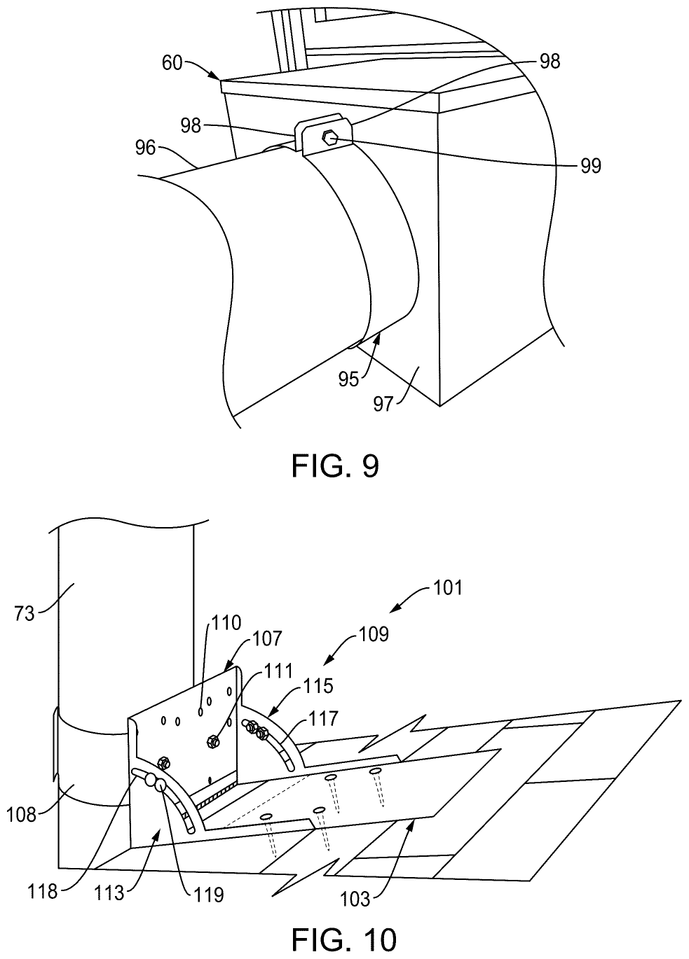

FIG. 10 shows one embodiment of the means for supporting the flue pipe 63. This means is a bracket 101 that is designed to be both attached to a roof and also be attached to the vertical section 73 of the flue pipe 63. The bracket includes a base plate 103 including a means for attaching the base plate to a roof, e.g., through holes in the base plate and fasteners. The bracket also an attachment plate 107 and a hinge 109 that links the attachment plate 107 to the base plate 103. The hinge 109 allows an angle between a surface of the base plate 103 and a surface of the attachment plate to change to accommodate different pitch roofs, even a flat roof.

A member support bracket 108 is also provided along with means for attaching the member support bracket 108 to the attachment plate, e.g., through holes 110 in the attachment plate 107 and fasteners 111. The bracket 108 also includes through holes so that fasteners extend through the support bracket 108 and attachment plate 107 for bracket securement.

The hinge 109 can be any configuration that allows pivoting or angular movement between the attachment plate 107 and base plate 103. The embodiment shown in FIG. 10 is a pair of upstanding flanges 113 on the base plate 103 and another pair of flanges 115 extending from the attachment plate 107. Each set of flanges includes arcuate slots 118 for the attachment plate 107 and arcuate slots 117 for the base plate 103. The slots 118 of the attachment plate align with the slots 117 of the base plate. With fasteners 119 linking the adjacent slots together, the attachment plate 107 can move with respect to the base plate 103 to accommodate the roof pitch. The fasteners 119 can be tightened, e.g., using wing nuts and bolts, to keep the attachment plate 107 in position for flue pipe or member support. In essence, the bracket 101 is a one piece design with the base plate linked to the attachment plate via the hinge. However, other pivoting arrangements could be used while maintaining the attachment plate for connection to a flue member and the base plate for connection to a roof.

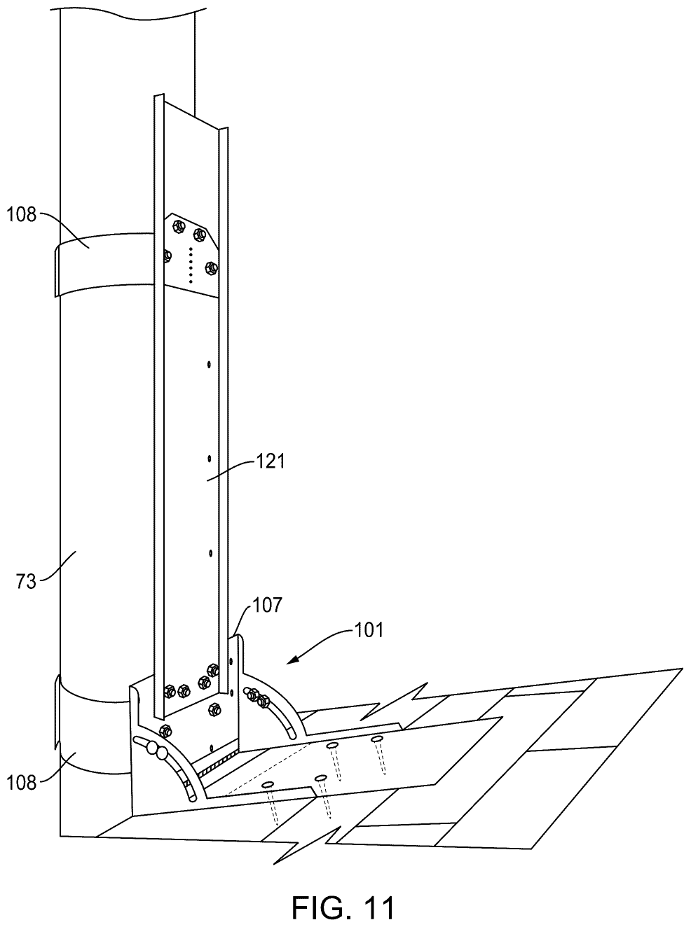

FIG. 11 shows the use of an extension bracket 121 in combination with the bracket 101 to provide additional support to the flue pipe vertical section 64. Another member support bracket 108 is provided to attach to the extension bracket 121 using through holes and fasteners in the extension bracket similar to the arrangement in the attachment plate 107. The extension bracket 121 is also attached to the attachment plate using similar means for attachment as used to attach the member support bracket 108 to the attachment plate 107, through holes in the attachment plate and fasteners.

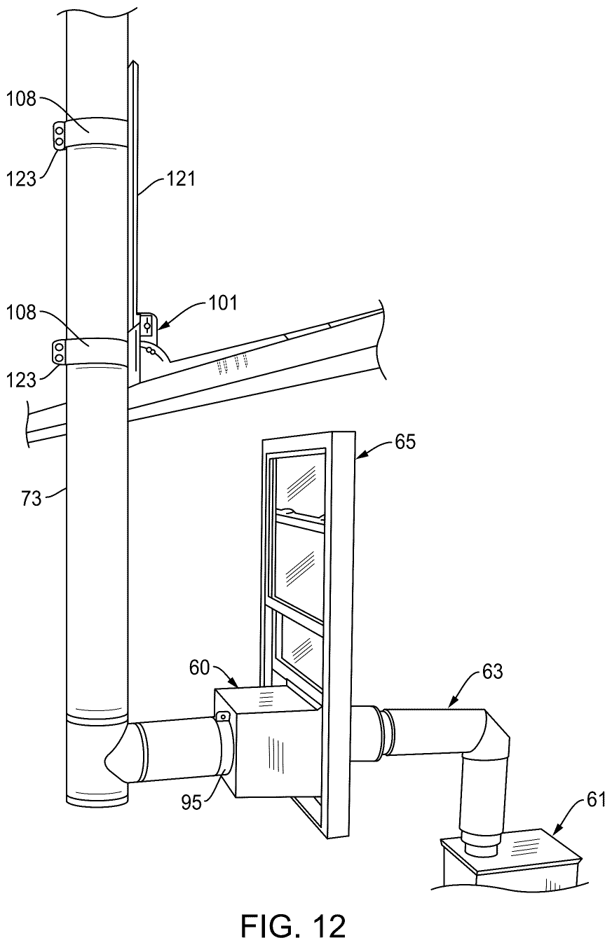

FIG. 12 shows another view of the window unit 60 using the bracket 101 and extension bracket 121. FIG. 12 also more clearly shows the member support bracket 108. The member support bracket 108 is shown as a strap, a central part attached to the attachment plate and flanged ends of the strap connected together at 123.

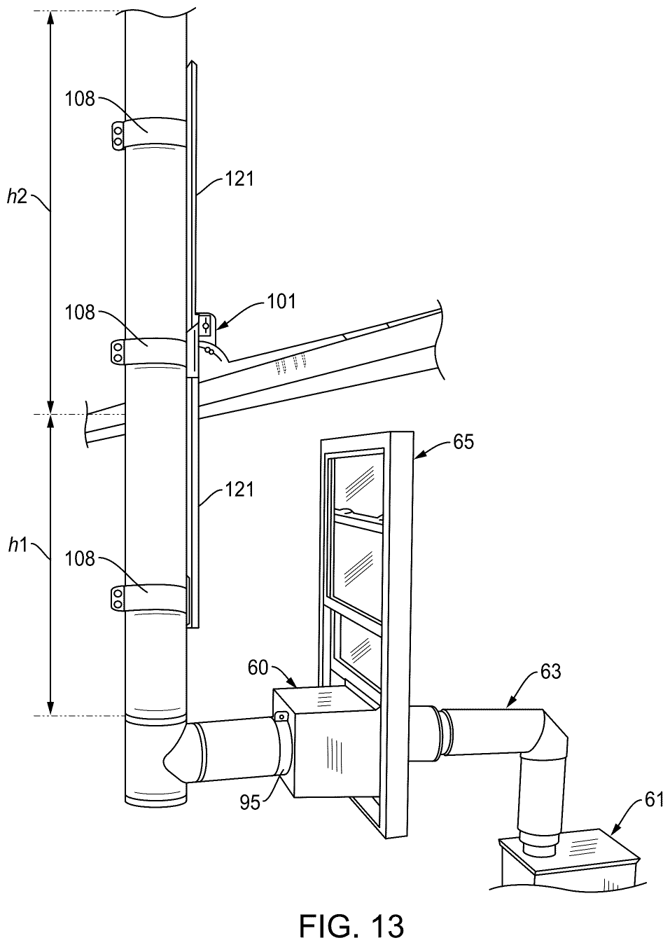

FIG. 13 shows another embodiment of the invention, wherein a pair of extension brackets 121 are used for flue pipe support. If the flue pipe extends more than 5 feet (h2) from the roof edge, the upper extension bracket is needed to meet code. If the distance from the roof edge to the flue pipe elbow is more than 8 feet (h1), the lower extension bracket is needed.

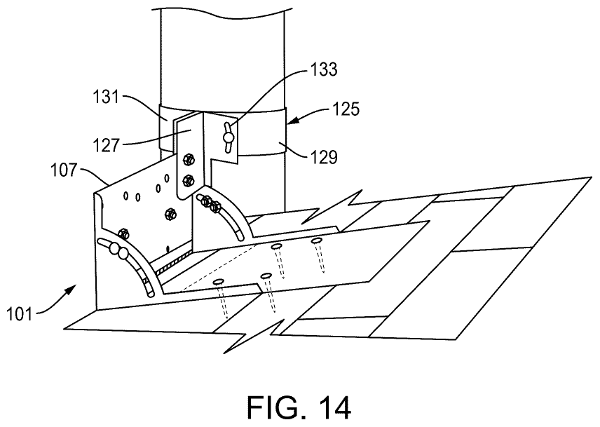

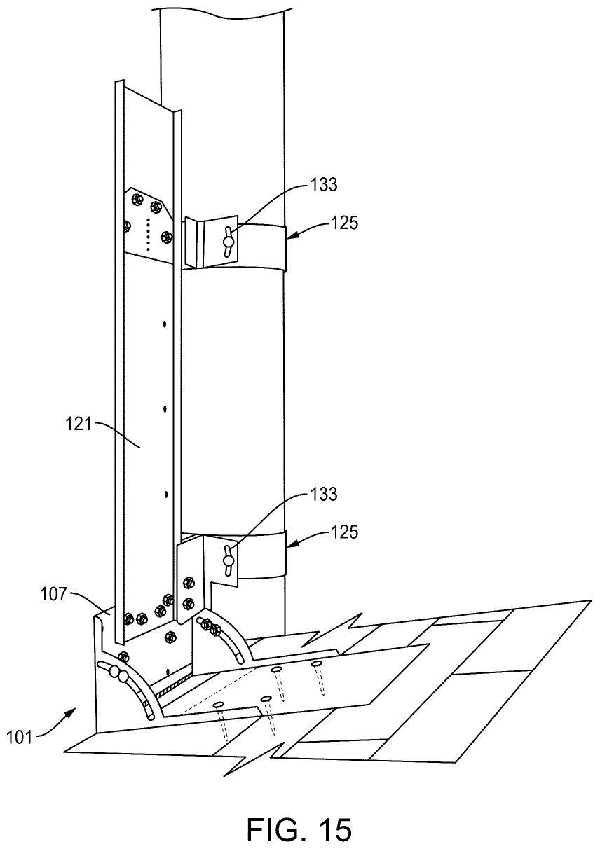

FIG. 14 shows a use of the bracket 101 in a different mode of attachment to a flue pipe. The vertical flue pipe may be located such that the attachment plate 107 cannot easily face the flue pipe as shown in FIG. 10. In the configuration of FIG. 15, the member support bracket is modified to accommodate a different mode of attachment to the attachment plate 107. The modified member support bracket is designated by the reference numeral 125 and it includes an extension 127 that aligns with the attachment plate 107 for attachment thereto using through holes and fasteners. The modified member support bracket 125 also includes a means for adjusting the angle of the modified member support bracket with respect to the attachment plate. In the illustrated means, the bracket 125 of the modified member support assembly is in at least two pieces 129 and 131 with an arcuate slot 133 in piece 131 and a threaded stud extending from the other piece 129, the stud allowed to travel in the slot 133 with the two pieces 129 and 131 secured together by a wing nut or the like. With this modified bracket 125, a flue pipe that is offset from the edge 135 of the roof can still be supported by the bracket 101.

FIG. 15 show the use of the extension bracket with a pair of the modified member support brackets 125 of FIG. 14.

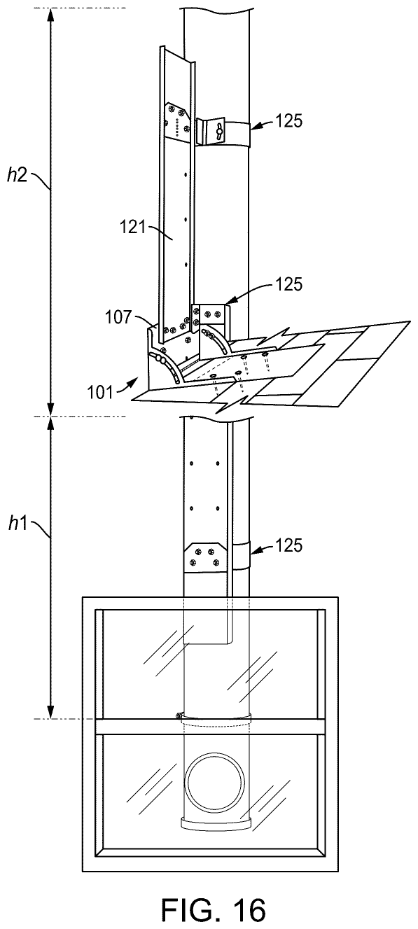

FIG. 16 shows the use two extension brackets with the modified member support bracket of FIG. 14. The window unit is not shown for clarity.

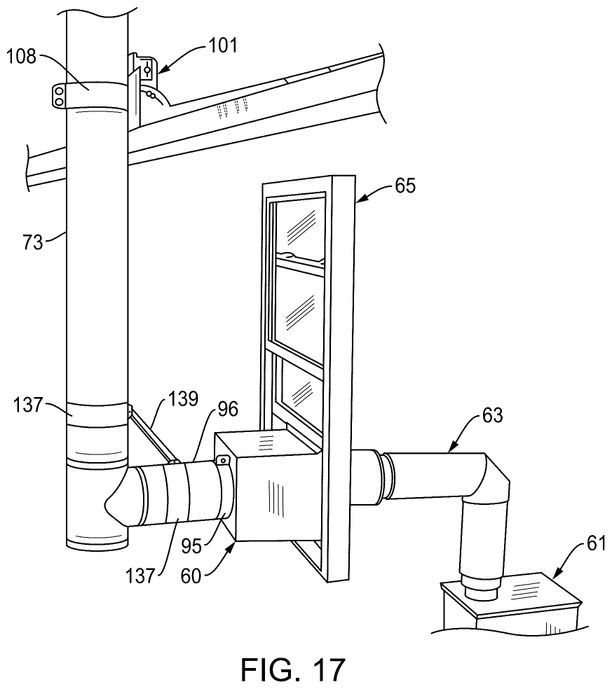

FIG. 17 shows the use of an optional brace assembly 135 that is located between a lower portion of the vertical section 73 of flue pipe and a horizontal section 96 extending from the window unit 60. The brace assembly 135, which includes a pair of collars 137, one around the vertical flue pipe 73 and the other around the horizontal flue pipe 96, the collars connected by the arm 139.

While the unit is illustrated as a window unit, it can also be installed in a wall as a replacement for a typical wall thimble. Known wall thimbles have basically a flanged male part, a flanged female part, and optional decorative cover. The male and female parts engage with the flanges thereof engaging the inside and outside surfaces of the wall having the thimble installed therein.

The inventive wall unit is shown in FIG. 18, the wall unit 140 having a cantilevered open bottomed box 141 similar to that of window unit 60. The wall unit includes a mounting flange 143 and collar 145 extending from a face 147 of the box 141. A male part is provided, which is designed to engage the collar 145 and provide an opening 151 to receive the flue pipe of a stove. A plate 153 is provided, which facilitates the engagement of the male and female parts 145 and 149. The wall unit 140 can be used with the bracket 101, for flue pipe support in the same manner as the window unit 60 as described above. This embodiment of the invention is an improvement over wall thimbles that have a male portion, intended to go on one side of a wall, and a female portion intended to go on another side of the wall, with the wall sandwiched between the two portions, the two portions also providing an opening for passage of a flue pipe therethrough. The improvement of the invention is including a wall unit as part of the female portion of the wall thimble, the wall unit including a flange for attachment to the wall and a female connection to receive a flanged male portion sized to engage the female connection of the wall unit. The improved thimble can also include a cover for the flanged male portion.

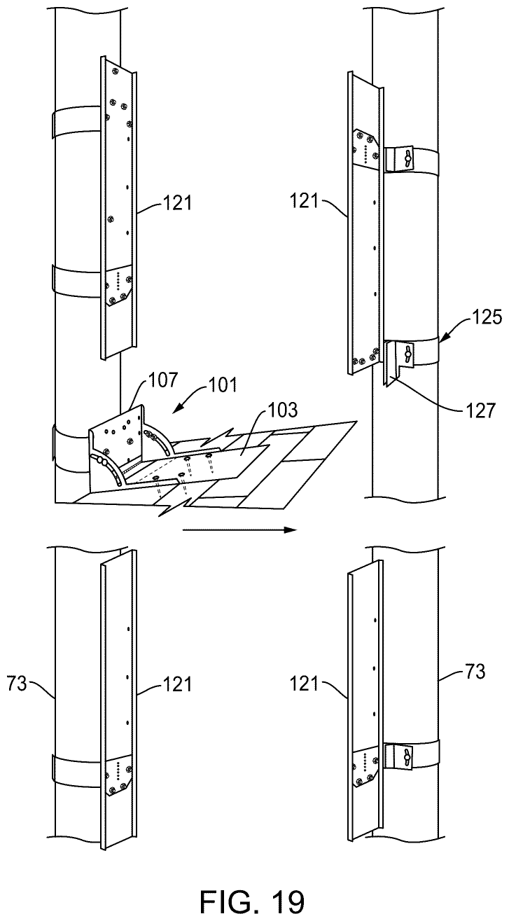

FIG. 19 shows a disassembled view of the roof bracket 101 of FIG. 11 in connection with the extension brackets 121. This view shows how the attachment plate 107 of the bracket 101 can interface with an upper or lower extension bracket on the left side of the drawings. In the alternative, the attachment plate 127 of the bracket 107 can interface with the extension 125 of the support bracket 127 in the flue member is offset from the plane of the attachment plate 125. In this alternative, the upper extension bracket provides additional support for the member 73 is needed.

The window unit of any of the embodiments above can be used with any kind of a wood stove.

The invention also includes a method of venting exhaust from a wood stove using the roof bracket and extension bracket using inventive window or wall units described above.

We claim:

1. A roof mounted member support device comprising:
a base plate including means for attaching the base plate to a roof; and
an attachment plate;
a hinge, the hinge between the base plate and attachment plate, the hinge allowing an angle between a surface of the attachment plate and a surface of the base plate to change to accommodate a pitch of the roof, and
means for attaching the attachment plate to at least one member support bracket, the means for attaching configured to attach to one or both of a member to be held by the roof mounted member support device and an extension bracket, the extension bracket including means for attaching the extension bracket to the member.

2. The device of claim 1, wherein the means for attaching the base plate to the roof comprises a plurality of openings or through holes in the base plate configured to receive fasteners for roof attachment.

3. The device of claim 1, wherein the attachment plate includes a pair of plate flanges, each flange having an arcuate slot therein and the base plate includes a pair of base plate flanges, each base plate flange including an arcuate slot therein, the arcuate slots of the attachment plate aligned with the arcuate slots of the base plate, and at least one locking connector engaging adjacent arcuate slots of each of the plate portion and base plate, each at least one locking connector holding the pivotal attachment between the attachment plate and base plate in place for member support.

4. The device of claim 1, wherein the means for attaching the attachment plate to the at least one member support bracket or extension bracket comprises a plurality of openings or through holes in the attachment plate.

5. The device of claim 1, wherein the member support bracket comprises a strap configured to surround the member and be attached to the attachment plate using the means for attaching the attachment plate to the member support bracket.

6. The device of claim 1, wherein the member support bracket includes a means for adjusting an angle of the member with respect to the attachment plate.

7. The device of claim 6, wherein the adjusting means comprises a bracket adapted to attach to the attachment plate, the bracket having an arcuate slot therein, the strap including an opening for receiving a fastener, the fastener engaging the arcuate slot and attaching the bracket to the strap, the arcuate slot allowing an angle between the bracket and the strap to be adjusted.

8. The device of claim 5, further comprising an extension bracket for attachment to the attachment plate.

9. The device of claim 8, further comprising an additional member support bracket assembly attaching to the extension bracket.

10. An assembly for venting a woodstove through a window in a dwelling comprising:
a window unit configured to fit within a window of the dwelling;
means for supporting at least a portion of a flue pipe extending from the window unit to an extent that the flue pipe, when extending vertically, is clear of an eave/soffit or wall of the dwelling;
means for closing off a gap not occupied by the window unit when the window unit is installed in a window space;
wherein the window unit is a metal box having an inlet opening and outlet opening to receive a portion of the flue pipe, the metal box having an interior space, a bottom of metal box open, the metal box including an air intake port, the air intake port having an outlet on one face of the metal box and an inlet in the interior space of the metal box, the inlet including an air intake regulator to adjust air intake through the inlet opening.

11. The window unit of claim 10, further comprising a collar adapted to mount to a portion of the flue pipe extending from the outlet opening, mounting of the collar to the portion of the flue pipe restricting movement of the flue pipe in the window unit.

12. The window unit of claim 10, further comprising a means for locking in place a window receiving the window unit.

13. The window unit of claim 12, where the locking in place means is a bracket with at least one set screw, the bracket including a lip to engage a groove of a window casing, the at least one set screw positioned in the bracket to move the bracket with respect to the window casing to secure the lip in the groove and prevent movement of a window sash.

14. The assembly comprising the window unit of claim 10 and a roof mounted member support device comprising:
a base plate including means for attaching the base plate to a roof; and
an attachment plate;
a hinge, the hinge between the base plate and attachment plate, the hinge allowing an angle between a surface of the attachment plate and a surface of the base plate to change to accommodate a pitch of the roof, and
means for attaching the attachment plate to at least one member support bracket, the means for attaching configured to attach to one or both of a member to be held by the roof mounted member support device and an extension bracket, the extension bracket including means for attaching the extension bracket to the member.

15. The assembly of claim 14, wherein the means for attaching the base plate to the roof comprises a plurality of openings or through holes in the base plate configured to receive fasteners for roof attachment.

16. The assembly of claim 14, wherein the attachment plate includes a pair of plate flanges, each flange having an arcuate slot therein and the base plate includes a pair of base plate flanges, each base plate flange including an arcuate slot therein, the arcuate slots of the attachment plate aligned with the arcuate slots of the base plate, and at least one locking connector engaging adjacent arcuate slots of each of the plate portion and base plate, each at least one locking connector holding the pivotal attachment between the attachment plate and base plate in place for member support.

17. The assembly of claim 14, wherein the means for attaching the attachment plate to the at least one member support bracket or extension bracket comprises a plurality of openings or through holes in the attachment plate.

18. The assembly of claim 14, wherein the member support bracket comprising a strap configured to surround the member and be attached to the attachment plate using the means for attaching the attachment plate to the member support bracket.

19. The assembly of claim 14, wherein the member support bracket includes a means for adjusting an angle of the member with respect to the attachment plate.

20. The assembly of claim 19, wherein the adjusting means comprises a bracket adapted to attach to the attachment plate, the bracket having an arcuate slot therein, the strap including an opening for receiving a fastener, the fastener engaging the arcuate slot and attaching the bracket to the strap, the arcuate slot allowing an angle between the bracket and the strap to be adjusted.

21. The assembly of claim 18, further comprising an extension bracket for attachment to the attachment plate.

22. The assembly of claim 21, further comprising an additional member support bracket assembly attaching to the extension bracket.
